(19) United States
(12) Patent Application Publication
(10) Pub. No.: US 2009/0312039 A1
(43) Pub. Date: Dec. 17, 2009

(54) GEO LOCATION POLLING AND REPORTING FOR MOBILES IN IDLE MODE

(76) Inventors: Jialin Zou, Randolph, NJ (US); Subramanian Vasudevan, Morristown, NJ (US)

Correspondence Address: FAY SHARPE/LUCENT, 1228 Euclid Avenue, 5th Floor, The Halle Building, Cleveland, OH, 44115-1843, US

(21) Appl. No.: 12/138,656

(22) Filed: Jun. 13, 2008

(51) Int. Cl. H04Q 7/20

(52) U.S. Cl. 455/456.6

(57) ABSTRACT

Systems and methods are described that facilitate obtaining geolocation information describing the geographical location of a mobile device while the device is in idle mode, without requiring the device to awaken and connect to an access network. A request for geolocation information is transmitted to the mobile over a control channel, and a geolocation report including geographical coordinates (latitude, longitude, altitude, etc.) is received from the mobile over an access channel. In this manner, the no user action, or user knowledge of the geolocation report, is required to obtain the report.

### BACKGROUND OF THE INVENTION

This invention relates to a method and apparatus for discovering the geographical location of idle mobile devices, without requiring the mobile devices to wake up and enter a connected state.

While the invention is particularly directed to the art of cellular communication systems, and will be thus described with specific reference thereto, it will be appreciated that the invention may have usefulness in other fields and applications. For example, the invention may be used other communication scenarios, other information transmission systems, and the like.

By way of background, as mobile communication devices (e.g., cellular phones, PDAs, smartphones, laptops, etc.) have become more advanced, many such devices are equipped with a global positioning transceiver. Many applications use or rely on a mobile device global positioning system (GPS) assisted report. Mobile device GPS geolocation information is delivered when a mobile device is in a connected or linked-up state (e.g., as in CDMA2000 EVDO). This requires that the AN first page or call the mobile device, and then the user of the mobile device must actively respond to the call in order cause the mobile device to negotiate with the AN to bring up a traffic channel.

However, there are scenarios in which it is desirable for a mobile device to report geolocation information without being required to “wake up” or otherwise enter a connected or “on” state. Such scenarios are not addressed by conventional systems that require the user to respond to a request or page for geolocation information. For instance, national security scenarios exist wherein it is desirable to receive such geolocation information without waking up the mobile device or requiring user action. Conventional systems similarly do not provide a mechanism for retrieving geolocation information from a user's mobile when the user is incapacitated, such as where the user has been injured and precise geolocation information could facilitate reducing rescue crew response time.

From a radio resource savings perspective, it is desirable not to negotiate a traffic channel solely for reporting geolocation information, which is limited (e.g., short) data and is not reported frequently.

The present invention contemplates new and improved systems and methods that resolve the above-referenced difficulties and others.

### SUMMARY OF THE INVENTION

A methods and systems for generating and retrieving geographical location information describing the location of an idle access terminal (e.g., a mobile communication device) are provided.

In one aspect, a system that retrieves geolocation information from an idle mobile access terminal (AT) comprises a processor that generates a geolocation request for an idle AT, a transmitter that transmits the request to the idle AT over a control channel, and a receiver that receives a geolocation report from the idle AT over an access channel.

According to another aspect, a system that provides geolocation information from an idle mobile access terminal (AT) comprises an idle mobile AT with a global positioning system (GPS) component that generates geolocation information describing its geographical location, and a receiver that receives a geolocation request over a control channel. The system further comprises a processor that generates a geolocation report in response to the geolocation request, and a transmitter that transmits the geolocation report over an access channel.

According to another aspect, a method of obtaining geolocation information from a mobile access terminal (AT) that remains in an idle state comprises generating a geolocation update message request that requests global positioning information describing the geographical location of the AT, transmitting the geolocation request on a control channel to the AT, and receiving a geolocation report comprising the requested information from the AT on an access channel.

Further scope of the applicability of the present invention will become apparent from the detailed description provided below. It should be understood, however, that the detailed description and specific examples, while indicating various embodiments of the invention, are given by way of illustration only, since various changes and modifications within the spirit and scope of the invention will become apparent to those skilled in the art.

### DESCRIPTION OF THE DRAWINGS

The subject innovation exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 illustrates a an access network (AN) that includes a plurality of cells or sectors, each of which has at least one base station that provides cellular service to its respective cell, wherein the geolocation of an access terminal (AT) can be polled by a network's central office or by another AT;

FIG. 2 illustrates a system that facilitates discovering geolocation information for an AT while the AT is in idle mode, without requiring user action or knowledge, which is advantageous in scenarios in which user knowledge or action is either unwanted or unavailable;

FIG. 3 illustrates the base station, which comprises a plurality of components for providing the various functions described herein;

FIG. 4 illustrates an AT that receives a request for geolocation information and generates and sends a geolocation report while in idle mode, in accordance with various aspects described herein;

FIG. 5 illustrates a method of requesting geolocation information from a mobile device or access terminal while the terminal is in idle mode, in accordance with one or more aspects described herein; and

FIG. 6 illustrates a method providing geolocation information from a mobile device or access terminal while the terminal is in idle mode, in accordance with one or more aspects described herein.

### DETAILED DESCRIPTION

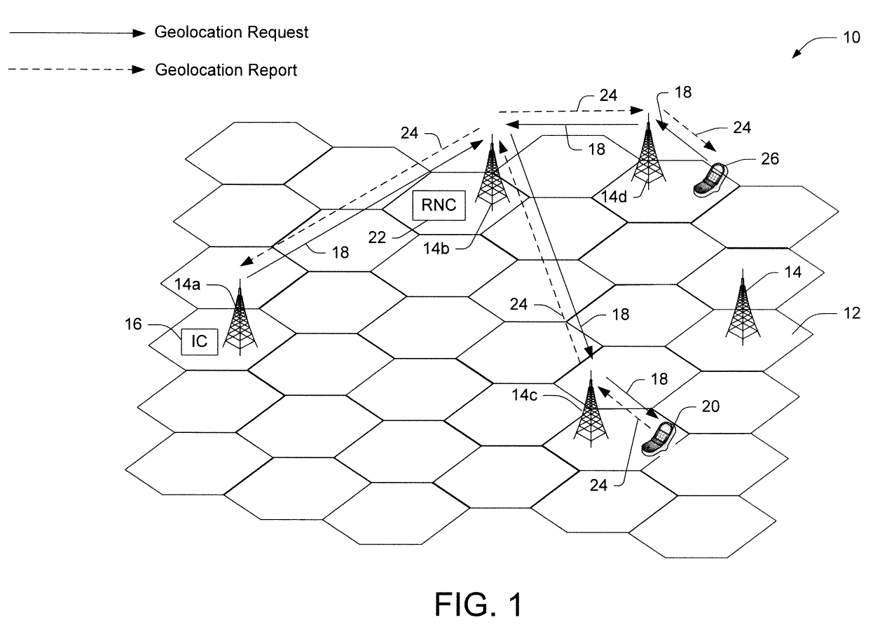

Referring now to the drawings wherein the showings are for purposes of illustrating the exemplary embodiments only and not for purposes of limiting the claimed subject matter, FIG. 1 provides a view of a system into which the presently described embodiments may be incorporated. As used herein, an access terminal (AT) may also be referred to as a user device or terminal, a mobile device or terminal, a cellular device or terminal, etc. An access network (AN) includes one or more base transceiver stations (BTS), which may also be referred to herein as a base station, a node B, or the like. Similarly, a communication link between the AT and the BTS may be referred to as an uplink or a reverse link when the AT is transmitting to the BTS, and as a downlink or a forward link when the BTS is transmitting to the AT. It will be appreciated that communication links between the AT and BTS may also include satellites that relay signals, multiple BTS, other type of relays, and the like.

According to one aspect, the air interface is enhanced to request an idle AT to report its geolocation information without alerting the AT user or requiring user action to initiate call setup procedures to establish a traffic channel. A geolocation request from the AN is transmitted from one or more base stations serving sectors or cells in which the AT is believed to be located, and includes a message or field that supports GPS polling. The response from the AT also includes a message or field for reporting geolocation. Additionally, a first AT can solicit geolocation information from a second AT while the second AT is in idle mode, in a similar manner. The idle AT then reports its geolocation information through an access channel.

As shown generally, FIG. 1 illustrates an access network (AN) 10 that includes a plurality of cells or sectors 12, each of which has at least one base station 14 that provides cellular service to its respective cell. An information center 16 transmits a geolocation request 18 (e.g., over an air link or backhaul connection) for a specific idle AT 20. The geolocation request is received by a radio network controller (RNC) or switch office 22, which relays the request 18 via a base station 14b in its serving cell or sector to a base station 14c in the sector in which the idle AT 22 is located. The base station 14c transmits the geolocation request 18 to the idle AT over a control channel. The idle AT 22 sends a geolocation report 24 over an access channel on the uplink to the base station 14c, which then relays the report 24 to the base station 14b at the RNC 22, which in turn relays the report 24 to the information center 16. Since the geolocation report contains limited data (e.g., latitude and longitude coordinate information, and optionally altitude information), the geolocation request 18 and report 24 need not be sent over a traffic channel, and therefore the idle AT 22 need not be awakened to report its geolocation.

According to another aspect, a second AT 26 requests the geolocation of the idle AT 20. For instance, a rescue worker, a federal agent or other officer, an employer or dispatcher, a parent, etc., can request the geolocation of an idle phone for a lost or injured party, a criminal, and employee, or a child, respectively. In another example, an owner of the idle phone can request its geolocation report (e.g., via the second AT, a land line, etc.) if the phone is lost. The request 18 is transmitted from a base station 14d in the serving sector of the second AT 26, to the base station 14b of the serving sector of the RNC 22, and on to the base station 14c of the serving sector of the idle AT 20. The idle AT 20 then transmits a geolocation report 24 over an access channel (e.g., without awakening, executing hand-shaking protocols and the like to negotiate a traffic channel, etc.) to its base station 14c, which relays the report 24 through the RNC's base station 14b to the base station 14d. Base station 14d then transmits the report 24 to the second AT 26 on a downlink connection.

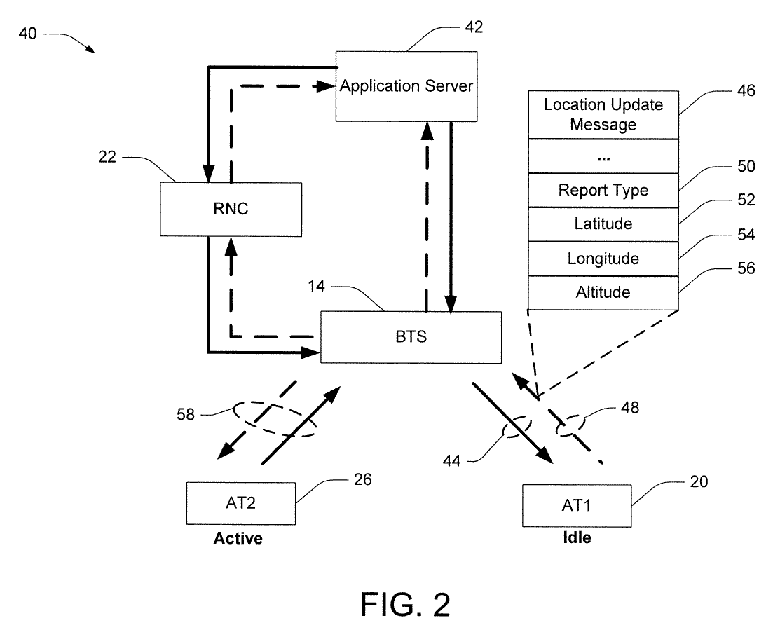

FIG. 2 illustrates a system 40 that facilitates discovering geolocation information for an AT while the AT is in idle mode, without requiring user action or knowledge, which is advantageous in scenarios in which user knowledge or action is either unwanted or unavailable. For instance, in certain national security scenarios (e.g., criminal tracking, etc.), it may be desirable to discover or monitor the location of the AT without alerting the user to the discovery. In emergency scenarios, it may be desirable to discover the location of the AT when the user is incapacitated and cannot respond to a request for such information. In other scenarios, parents can discover or monitor the location of their children; employers can monitor the location(s) of one or more employees; etc. Another advantage of the system resides in economizing radio resources, since the AT reports its geolocation upon request by the AN without negotiation of a traffic channel, such as the traffic channel in high-rate packet data (HRPD) standard (CDMA2000 EVDO). In such systems, the overhead associated with negotiating a traffic channel can be more than the geolocation information payload.

The system 40 includes the RNC 22, and optionally the information center 16. The RNC 22 is communicatively coupled to an application server 42, and to at least one BTS 14. According to one aspect, a geolocation request for the idle AT 20 is generated at the information center 16 and transmitted to the RNC 22, which then transmits the request to the BTS 14. Transmission of the request up to this point may occur over an air link or backhaul connection. However, to avoid awakening the idle AT 20, the BTS 14 transmits the request to the idle AT 20 over a control channel 44.

Upon receiving the request, the idle AT 20 transmits a geolocation report including a location update message 46 over an access channel. The location update message includes various air interface fields that support idle AT geolocation updates upon request, including a “report-type” identifier 50, which may be a header or the like including information identifying the message as a geolocation report. The message 46 additionally includes latitude information 52, longitude information 54, and altitude information 56. The location update message 46 is received by the BTS 14, which then relays the message 46 to the RNC 22 (e.g., directly or via one or more other BTSs, satellites, etc.) and/or on to the requesting information center 16.

In another embodiment, a second AT 26 sends a request for the geolocation of the idle AT 20, over a traffic channel 58 or other air link, to the BTS 14. The BTS 14 transmits the request on the control channel 44 on the forward link to the idle AT 20, which then transmits the location update message 46 on the access channel 48 on the reverse link.

According to another feature, the application server 42 maps the GPS information (e.g., GPS and/or AT identity information and the like) of the idle AT to the geolocation coordinates provided in the report and relays the GPS information to the requesting AT 26. For example, when an AT requests the geolocation from an idle AT, the reporting (idle) AT initially reports its latitude, longitude, and altitude to the AN. If the requesting AT does not have geographical map database, the AN first relays the reported geolocation information to the application server 42 (e.g., via a backhaul connection or the like). The application server 42 maps the geolocation information to a geographical map corresponding to the reported coordinates and altitude, and delivers the geolocation information on the map to the AN. The AN sends the mapped geolocation information to the requesting AT over, for instance an air link (e.g., a traffic channel or the like). In another example, if the requesting AT has a geographical map database (not shown), then the AN can optionally relay only the coordinate information to the requesting AT. Mapping of the geolocation coordinate information to a geographical map can then be performed by the requesting AT.

In order to provide the enhanced HRPD air interface messages described herein, the geolocation request message is sent from the AN (e.g., via the BTS 14) to the AT 20 over the control channel 44 on the forward link. The location request message is enhanced at the air interface application layer with by a “report type” field or identifier, which is the counterpart of the report-type field 50 of the location update message 46, and which identifies the geolocation request for a mobile device in idle mode and indicates that an accurate GPS geolocation report is desired over an access channel on the reverse link. Additionally, a “RouteUpdateRequest” message is enhanced at the air interface connection layer by the “report type” field to permit the AN to use the geolocation information and to indicate what RouteUpdate report type is being requested.

The geolocation report message or field is sent through the access channel 48 on the reverse link from the idle AT 20 to the AN via the BTS 14, and is enhanced at the air interface application layer by the “report type” field 50, as well as the latitude field 52, longitude field 54, and the altitude field 56. Additionally, the RouteUpdate message for the report is enhanced at the air interface connection layer by the report type and geolocation coordinate fields.

With regard to the AN, the geolocation request is sent on the data plane to trigger the control plane request message. This is in contrast to conventional mechanisms that send “LocationNotification” and RouteUpdate requests on the control plane to trigger traffic channel negotiation by the AT. Reported geolocation information can then be optionally converted to the data plane for upper layer applications.

With regard to the AT 20, when in idle mode, the AT reports geolocation information over the access channel 48 in response to the request received over the control channel 44. Geolocation information is provided by a GPS unit (not shown) in the AT 20. According to another aspect, geolocation information is generated by triangulating the position of the idle AT 20.

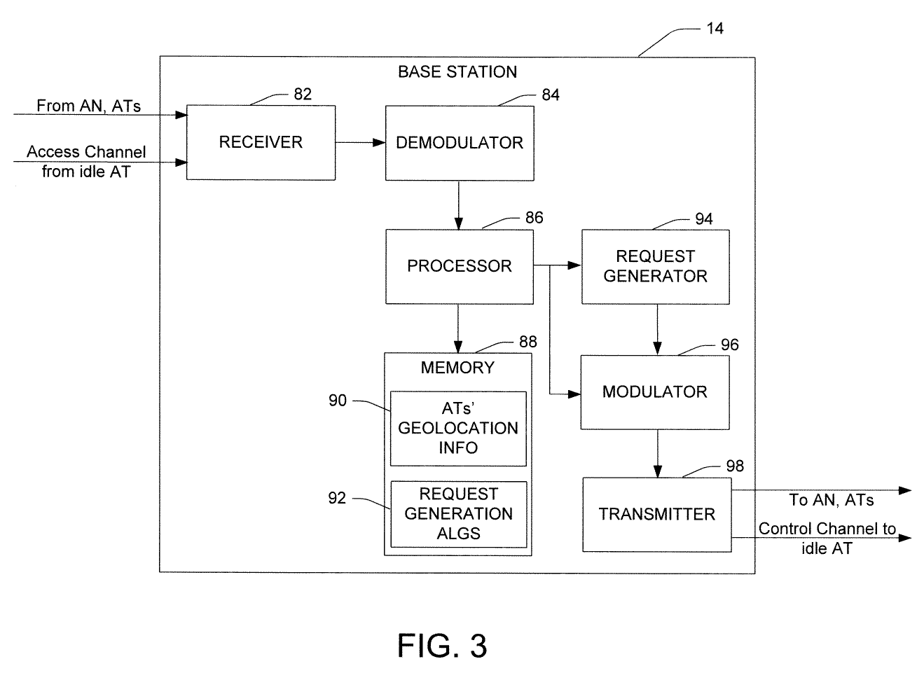

FIG. 3 illustrates the base station 14, which comprises a plurality of components for providing the various functions described herein. A receiver 82 receives communications from the AN and one or more ATs (not shown). A demodulator 84 receives data from the receiver 82 and demodulates, demultiplexes, etc., the received signals for processing by a processor 86. The processor is capable of generating, modifying, relaying, etc., received communication signals, which are then modulated by a modulator 96 and transmitted by a transmitter 98.

Upon receipt of a location information request (e.g., a communication signal including a request that the base station generate a geolocation update message) received by the base station) for a specific AT, the processor accesses a memory component 88 that stores geolocation information 90 for a plurality of ATs that have been in communication with the base station 14, as well as one or more computer-executable geolocation request generation algorithm(s) 92 for generating a geolocation request. A request generator 94, which may be a processor separate from or integral to the processor 86, executes the request generation algorithm(s) 92 to generate a geolocation request for the specified AT. The geolocation request includes, for instance, a request type field that identifies the request as a geolocation request and that may contain other additional information (e.g., header information, base station identity information etc.). The request is then optionally modulated or otherwise encoded by the modulator 96 and transmitted by the transmitter 98 over a control channel to the specified AT.

The AT receives the geolocation request over the control channel, and generates a geolocation report while in idle mode (e.g., without “waking up” or requiring user action), which is transmitted back to the base station 14 over an access channel. The receiver 82 receives the geolocation report over the access channel, demodulates the report, and the processor 86 stores the geolocation information for the specified AT to the geolocation information component 90 in the memory 88. The base station then sends an acknowledgement back to the reporting AT and transmits (e.g., relays) the geolocation report to the requesting entity (e.g., another base station, an RNC, an information center, another AT, etc.) over a traffic channel, which may be the same traffic channel on which the communication signal comprising the location information request was received, or a different traffic channel.

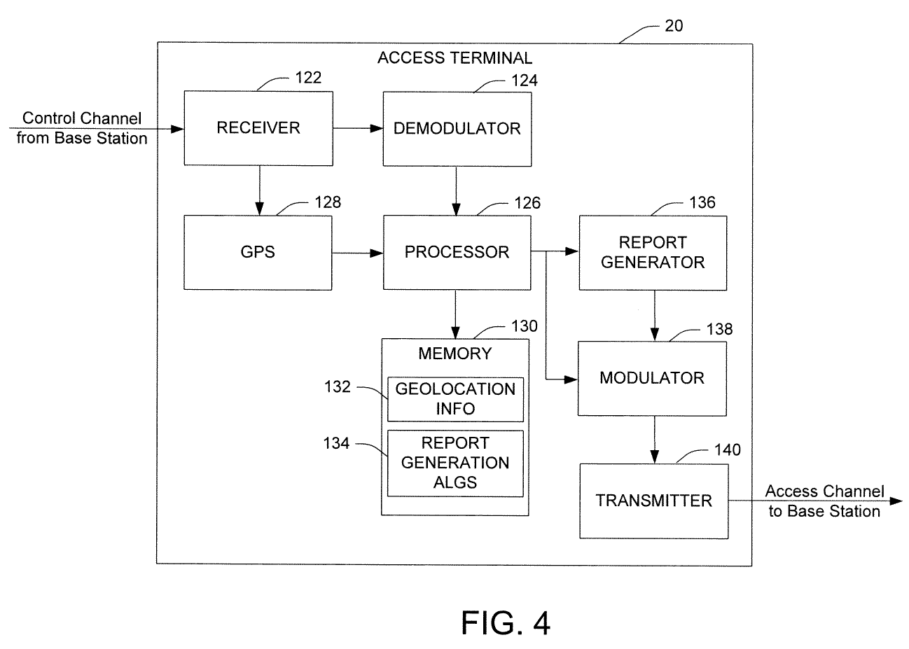

FIG. 4 illustrates an AT (e.g., a user device, cell phone, etc.) that receives a request for geolocation information and generates and sends a geolocation report while in idle mode, in accordance with various aspects described herein. The AT 20 comprises a receiver 122 that receives a geolocation request from a base station over a control channel. The received request is demodulated, demultiplexed, etc., by a demodulator 124, and forwarded to a processor 126.

Continuously or periodically, a GPS component 128 communicates via the AT 20 with the AN and/or satellites comprised thereby to generate and/or update geolocation information describing the current location of the AT 20, including geographic coordinates (e.g., latitude, longitude, etc.) and optionally altitude information. In another embodiment, the processor (or the AN) executes a triangulation algorithm or software stored in the memory 130 (or in memory associated with the AN) to triangulate the position of the idle AT using known geographical coordinates of base stations in communication with the idle AT, as an alternative to the GPS component. For instance, beacon signals from one or more nearby base stations can be received, and header information or the like included in the beacon signals can be processed to identify the base stations. Base station identities can then be cross-referenced to base station coordinates, and the location of the idle AT can be triangulated there from.

The processor accesses a memory component 130 having the geolocation information 132 stored therein to retrieve current geolocation information and one or more geolocation report generation algorithm(s) 134. A report generator 136, which may be a processor separate from or integral to the processor 126, executes the report generation algorithm(s) 134 to generate a geolocation report for the AT 20. The geolocation report includes, for instance, a report type field that identifies the report as a geolocation report and that may contain other additional information (e.g., header information, AT 20 or GPS component 128 identity information etc.). The report is then optionally modulated or otherwise encoded by a modulator 138 and transmitted by a transmitter 140 over an access channel to the requesting base station. In this manner, the AT remains in idle mode and provides requested geolocation information without waking up or entering a connected state.

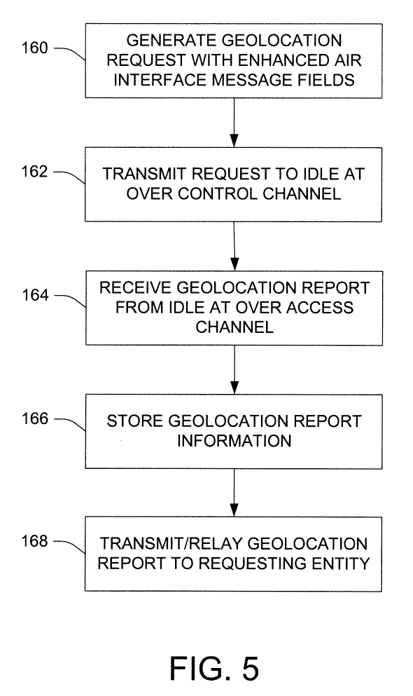

FIG. 5 illustrates a method of requesting geolocation information from a mobile device or access terminal while the terminal is in idle mode, in accordance with one or more aspects described herein. At 160, a geolocation update message request is generated with enhanced air interface message fields (e.g., report-type, latitude, longitude, altitude, etc.). For instance, the request can be generated at a base station in the serving sector of an AT to which the request is to be sent as an over-the air geolocation request. In another example, the request is generated at an information center or at another AT, and relayed to an idle AT for which the information is requested.

At 162, the geolocation information request is transmitted to an idle AT over a control channel, to avoid causing the AT to wake up or otherwise require user action or user knowledge of the request. At 164, a geolocation report containing the requested geolocation information is received over an access channel. At 166, geolocation information received in the report is optionally stored to persistent memory. At 168, the geolocation report is transmitted or relayed to the requesting entity (e.g., another base station, an RNC, an information center, another access terminal, etc.). Transmission of the report from the base station can occur over a traffic channel.

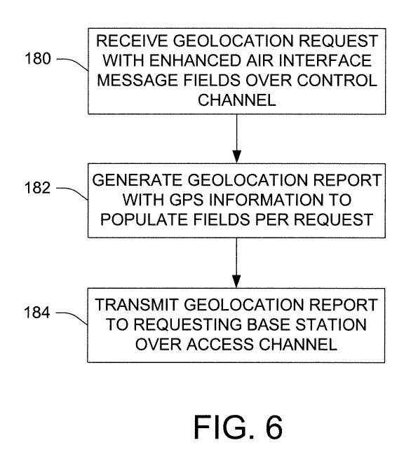

FIG. 6 illustrates a method providing geolocation information from a mobile device or access terminal while the terminal is in idle mode, in accordance with one or more aspects described herein. At 180, a geolocation update message request is received, with geolocation fields (e.g., report type, geographic coordinates, altitude, etc.) specified, over a control channel. Because the request is received over a control channel, an idle AT receiving the request is not required to enter a connected state, negotiate traffic channel resources, and the like. IN this manner, the AT is permitted to remain idle.

At 182, the AT generates a geolocation report that is self-identifying (e.g., via the report-type field) and contains the requested geolocation information (e.g., latitude, longitude, and/or altitude) of the AT (or a GPS component therein). At 184, the AT transmits the geolocation report over an access channel, which does not require the AT to enter a connected state or otherwise alert the user to, or require user action to perform, the transmission of the report.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. A system that retrieves geolocation information from an idle mobile access terminal (AT), comprising:
a processor that generates a geolocation request for an idle AT;
a transmitter that transmits the request to the idle AT over a control channel; and
a receiver that receives a geolocation report from the idle AT over an access channel.

2. The system according to claim 1, further comprising a memory that stores one or more computer-executable instructions, which is/are executed by the processor to generate the geolocation quest.

3. The system according to claim 1, wherein the geolocation request comprises a report-type field that identifies the request as a geolocation request.

4. The system according to claim 1, wherein the transmitter transmits the received geolocation report over a backhaul or air link connection to a requesting entity.

5. The system according to claim 4, wherein the requesting entity is one or more of an information center, a radio network controller (RNC), a base transceiver station (BTS), or non-idle AT.

6. The system according to claim 1, employed in a base transceiver station (BTS).

7. The system according to claim 6, wherein the receiver receives a communication signal over a traffic channel or backhaul connection that triggers the generation of the geolocation request.

8. The system according to claim 7, wherein the communication signal is received from one or more of an information center, a radio network controller (RNC), a base transceiver station (BTS), or non-idle AT.

9. A system that provides geolocation information from an idle mobile access terminal (AT), comprising:
an idle mobile AT with a global positioning system (GPS) component that generates geolocation information describing its geographical location;
a receiver that receives a geolocation request over a control channel;
a processor that generates a geolocation report in response to the geolocation request; and
a transmitter that transmits the geolocation report over an access channel.

10. The system according to claim 9, further comprising a memory that stores geolocation information generated by the GPS component.

11. The system according to claim 10, wherein the memory further stores computer-executable instructions that are executed by the processor to generate the geolocation report.

12. The system according to claim 9, wherein the geolocation report includes a report-type field that identifies the report as a geolocation report.

13. The system according to claim 9, wherein the geolocation report comprises one or more of a latitude field, a longitude field, and an altitude field, in which are provided at least one of a latitude coordinate, a longitude coordinate, and an altitude of the idle AT, respectively.

14. A method of obtaining geolocation information from a mobile access terminal (AT) that remains in an idle state, comprising:
generating a geolocation update message request that requests geolocation information describing the geographical location of the AT;
transmitting the geolocation request on a control channel to the AT; and
receiving a geolocation report comprising the requested information from the AT on an access channel.

15. The method according to claim 14, further including receiving a communication signal from a requesting entity over a first traffic channel, wherein the communication signal triggers the processor to generate the geolocation request.

16. The method according to claim 15, further comprising transmitting the geolocation report to the requesting entity over at least one of the first traffic channel or a second traffic channel.

17. The method according to claim 15, wherein the requesting entity is one or more of an information center, a radio network controller (RNC), a base transceiver station (BTS), or non-idle AT.

18. The method according to claim 15, wherein the requesting entity is a non-idle AT without a geographical map database, and further comprising:
mapping geolocation information including at least one of latitude, longitude and altitude information included in the geolocation report to a geographic map;
providing a mapped geographical location of the idle AT to the non-idle AT.

19. The method according to claim 15, wherein the requesting entity is a non-idle AT with a geographical map database, and further comprising:
providing the geolocation information including at least one of latitude, longitude and altitude information included in the geolocation report to the non-idle for mapping to a geographical map.

20. The method according to claim 15, further comprising including in the geolocation request a report-type indicator that identifies the request as a geolocation request.

21. The method according to claim 14, further including receiving a communication signal from a requesting entity over at least one of a backhaul channel and an air link, wherein the communication signal triggers the processor to generate the geolocation request, which is an over-the-air geolocation request.
